(19) United States
(12) Patent Application Publication
(10) Pub. No.: US 2007/0285737 A1
(43) Pub. Date: Dec. 13, 2007

(54) IMAGE FORMING APPARATUS, METHOD OF CONTROLLING IMAGE FORMING APPARATUS, AND CONTROLLING PROGRAM FOR IMAGE FORMING APPARATUS

(75) Inventor: Syusaku Takara, Shinagawa-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/758,111

(22) Filed: Jun. 5, 2007

(30) Foreign Application Priority Data
Jun. 7, 2006 (JP) 2006-158335

(51) Int. Cl. H04N 1/04

(52) U.S. Cl. 358/474

(57) ABSTRACT

In an image forming apparatus, method of controlling the image forming apparatus, and controlling program for the image forming apparatus according to the invention , a first detecting unit detects whether a first original is set on a platen glass or not, a second detecting unit detects whether a second original is set on a scanning device in order to scan originals in series or not, a determining unit determines that at least one of the first original and the second original is scanned in response to a detection signal generated by the first detecting unit when the first detecting unit detects the setting of the first original, and a detection signal generated by the second detecting unit when the second detecting unit detects the setting of the second original, a first judging unit judges whether the first original is a setting seat or not when the first original is scanned in accordance with determination by the determining unit, and a changing unit changes a setting of the image forming apparatus based on a data related to the setting seat as the first original if the first judging unit judges that the first original is the setting seat. With an image forming apparatus, method of controlling the image forming apparatus, and controlling program for the image forming apparatus according to the invention, deterioration of the setting seat can be prevented and availableness can be improved.

### BACKGROUND OF THE INVENTION

1. Field of the Invention

The present invention relates to an image forming apparatus, method of controlling the image forming apparatus, and controlling program for the image forming apparatus. In particular, the invention relates to the image forming apparatus provided with an automatic document feeder, method of controlling the image forming apparatus, and controlling program for the image forming apparatus.

2. Related Art

In Japanese Unexamined Patent Application Publication No. 2001-282055, a technology is proposed with which an image forming apparatus reads in a setting seat where a setting data related to the image forming apparatus is described in advance, and imports a setting of the image forming apparatus.

With the technology proposed in Japanese Unexamined Patent Application Publication No. 2001-282055, a user puts the setting seat where the setting data related to the image forming apparatus is described by a predetermined format in advance into originals as the first original of them, and the image forming apparatus reads in one original. Thereafter, if the image forming apparatus determines the first original is the setting seat, the image forming apparatus can change the setting of the image forming apparatus in accordance with the setting data which is described in advance in the setting seat, and perform print processing of subsequent originals by using a setting of the image forming apparatus after changed.

However, with the technology proposed in Japanese Unexamined Patent Application Publication No. 2001-282055, it is necessary for the image forming apparatus to always read in the setting seat with originals in the case of changing the setting of the image forming apparatus. Therefore, deterioration of the setting seat occurs if the same setting seat is repeatedly used. It takes a lot of trouble with using the setting seat if the user manages the setting seat by putting the setting seat into a clear case. Thus, the image forming apparatus is not user-friendly for a user.

### SUMMARY OF THE INVENTION

The present invention was made in the view of the circumstances encouraged in the prior art mentioned above, and it is an object of the present invention to provide an image forming apparatus, method of controlling the image forming apparatus, and controlling program for the image forming apparatus.

In order to solve the above-mentioned problems, an image forming apparatus according to an aspect of the present invention includes: a first detecting unit configured to detect whether a first original is set on a platen glass or not; a second detecting unit configured to detect whether a second original is set on a scanning device in order to scan originals in series or not; a determining unit configured to determine that at least one of the first original and the second original is scanned in response to a detection signal generated by the first detecting unit when the first detecting unit detects the setting of the first original, and a detection signal generated by the second detecting unit when the second detecting unit detects the setting of the second original; a first judging unit configured to judge whether the first original is a setting seat or not when the first original is scanned in accordance with determination by the determining unit; and a changing unit configured to change a setting of the image forming apparatus based on a data related to the setting seat as the first original if the first judging unit judges that the first original is the setting seat.

In order to solve the above-mentioned problems, a method of controlling an image forming apparatus according to an aspect of the present invention includes: detecting whether a first original is set on a platen glass or not; detecting whether a second original is set on a scanning device in order to scan originals in series or not; determining that at least one of the first original and the second original is scanned in response to a detection signal generated when the setting of the first original is detected, and a detection signal generated when the setting of the second original is detected; judging whether the first original is a setting seat or not when the first original is scanned in accordance with determination; and changing a setting of the image forming apparatus based on a data related to the setting seat as the first original if it is judged that the first original is the setting seat.

In order to solve the above-mentioned problems, a controlling program for an image forming apparatus according to an aspect of the present invention causes a computer to execute a procedure that includes: detecting whether a first original is set on a platen glass or not; detecting whether a second original is set on a scanning device in order to scan originals in series or not; determining that at least one of the first original and the second original is scanned in response to a detection signal generated when the setting of the first original is detected, and a detection signal generated when the setting of the second original is detected; judging whether the first original is a setting seat or not when the first original is scanned in accordance with determination; and changing a setting of the image forming apparatus based on a data related to the setting seat as the first original if it is judged that the first original is the setting seat.

In order to solve the above-mentioned problems, an image forming apparatus according to an aspect of the present invention includes: a first detecting unit configured to detect whether a first original is set on a platen glass or not; a second detecting unit configured to detect whether a second original is set on a scanning device in order to scan originals in series or not; a determining unit configured to determine that at least one of the first original and the second original is scanned in response to a detection signal generated by the first detecting unit when the first detecting unit detects the setting of the first original, and a detection signal generated by the second detecting unit when the second detecting unit detects the setting of the second original; a judging unit configured to judge whether the second original is a setting seat or not when the second original is scanned in accordance with determination by the determining unit; a changing unit configured to change a setting of the image forming apparatus each time based on a data related to the setting seat as the second original if the judging unit judges that the first original is the setting seat; and an executing unit configured to execute an image forming operation by using the setting of the image forming apparatus changed by the changing unit until the changing unit furthermore changes the setting of the image forming apparatus with use of another setting seat.

In order to solve the above-mentioned problems, a method of controlling an image forming apparatus according to an aspect of the present invention includes: detecting whether a first original is set on a platen glass or not; detecting whether a second original is set on a scanning device in order to scan originals in series or not; determining that at least one of the first original and the second original is scanned in response to a detection signal generated when the setting of the first original is detected, and a detection signal generated when the setting of the second original is detected; judging whether the second original is a setting seat or not when the second original is scanned in accordance with determination; changing a setting of the image forming apparatus each time based on a data related to the setting seat as the second original if it is judged that the first original is the setting seat; and executing an image forming operation by using the setting of the image forming apparatus changed until the setting of the image forming apparatus is furthermore changed with use of another setting seat.

In order to solve the above-mentioned problems, a controlling program for an image forming apparatus according to an aspect of the present invention causes a computer to execute a procedure that includes: detecting whether a first original is set on a platen glass or not; detecting whether a second original is set on a scanning device in order to scan originals in series or not; determining at least one of the first original and the second original is scanned in response to a detection signal generated when the setting of the first original is detected, and a detection signal generated when the setting of the second original is detected; judging whether the second original is a setting seat or not when the second original is scanned in accordance with determination; changing a setting of the image forming apparatus each time based on a data related to the setting seat as the second original if it is judged that the first original is the setting seat; executing an image forming operation by using the setting of the image forming apparatus changed until the setting of the image forming apparatus is furthermore changed with use of another setting seat.

In the image forming apparatus according to the invention, it is detected whether a first original is set on a platen glass or not; a second detecting unit configured to detect whether a second original is set on a scanning device in order to scan originals in series or not, it is determined that at least one of the first original and the second original is scanned in response to a detection signal generated by the first detecting unit when the first detecting unit detects the setting of the first original, and a detection signal generated by the second detecting unit when the second detecting unit detects the setting of the second original; it is judged whether the first original is a setting seat or not when the first original is scanned in accordance with determination by the determining unit; and a setting of the image forming apparatus is changed based on a data related to the setting seat as the first original if the first judging unit judges that the first original is the setting seat.

In the method of controlling the image forming apparatus according to the invention, it is detected whether a first original is set on a platen glass or not; a second detecting unit configured to detect whether a second original is set on a scanning device in order to scan originals in series or not, it is determined that at least one of the first original and the second original is scanned in response to a detection signal generated by the first detecting unit when the setting of the first original is detected by the first detecting unit, and a detection signal generated by the second detecting unit when the setting of the second original is detected by the second detecting unit; it is judged whether the first original is a setting seat or not when the first original is scanned in accordance with determination by the determining unit; and a setting of the image forming apparatus is changed based on a data related to the setting seat as the first original if the first judging unit judges that the first original is the setting seat.

In the controlling program for the image forming apparatus for causing a computer to execute a procedure according to the invention, it is detected whether a first original is set on a platen glass or not; a second detecting unit configured to detect whether a second original is set on a scanning device in order to scan originals in series or not, it is determined that at least one of the first original and the second original is scanned in response to a detection signal generated by the first detecting unit when the setting of the first original is detected by the first detecting unit, and a detection signal generated by the second detecting unit when the setting of the second original is detected by the second detecting unit; it is judged whether the first original is a setting seat or not when the first original is scanned in accordance with determination by the determining unit; and a setting of the image forming apparatus is changed based on a data related to the setting seat as the first original if the first judging unit judges that the first original is the setting seat.

In the image forming apparatus according to the invention, it is detected whether a first original is set on a platen glass or not; it is detected whether a second original is set on a scanning device in order to scan originals in series or not, it is determined that at least one of the first original and the second original is scanned in response to a detection signal generated when the setting of the first original is detected, and a detection signal generated when the setting of the second original is detected; it is judged whether the second original is a setting seat or not when the second original is scanned in accordance with determination; changing a setting of the image forming apparatus each time based on a data related to the setting seat as the second original if it is judged that the first original is the setting seat; and an image forming operation is executed by using the setting of the image forming apparatus changed until the setting of the image forming apparatus is furthermore changed with use of another setting seat.

In the method of controlling the image forming apparatus according to the invention, it is detected whether a first original is set on a platen glass or not; it is detected whether a second original is set on a scanning device in order to scan originals in series or not, it is determined that at least one of the first original and the second original is scanned in response to a detection signal generated in the first detecting step when the setting of the first original is detected, and a detection signal generated when the setting of the second original is detected; it is judged whether the second original is a setting seat or not when the second original is scanned in accordance with determination; changing a setting of the image forming apparatus each time based on a data related to the setting seat as the second original if it is judged that the first original is the setting seat; and an image forming operation is executed by using the setting of the image forming apparatus changed until the setting of the image forming apparatus is furthermore changed with use of another setting seat.

In the controlling program for the image forming apparatus for causing a computer to execute a procedure according to the invention, it is detected whether a first original is set on a platen glass or not; it is detected whether a second original is set on a scanning device in order to scan originals in series or not, it is determined that at least one of the first original and the second original is scanned in response to a detection signal generated when the setting of the first original is detected, and a detection signal generated when the setting of the second original is detected; it is judged whether the second original is a setting seat or not when the second original is scanned in accordance with determination; changing a setting of the image forming apparatus each time based on a data related to the setting seat as the second original if it is judged that the first original is the setting seat; and an image forming operation is executed by using the setting of the image forming apparatus changed until the setting of the image forming apparatus is furthermore changed with use of another setting seat.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is a diagram showing an external construction of an image forming apparatus according to the present invention;

FIG. 2 is a diagram showing a detail construction of a first detection unit provided in an image forming apparatus in FIG. 1;

FIG. 3 is a diagram showing a detail construction of a second detection unit provided in an image forming apparatus in FIG. 1;

FIG. 4 is a block diagram showing a functional construction executable by an image forming apparatus in FIG. 1 to FIG. 3;

FIG. 5 is a flowchart for describing system setting change processing of the image forming apparatus in FIG. 4;

FIG. 6 is a flowchart for describing another system setting change processing of the image forming apparatus in FIG. 4;

FIG. 7 is a flowchart for describing another system setting change processing of the image forming apparatus in FIG. 4;

FIG. 8 is a flowchart for describing another system setting change processing of the image forming apparatus in FIG. 4; and

FIG. 9 is a flowchart for describing another system setting change processing of the image forming apparatus in FIG. 4.

### DESCRIPTION OF THE PREFERRED EMBODIMENTS

With reference to drawings, embodiments of the present invention will be described below.

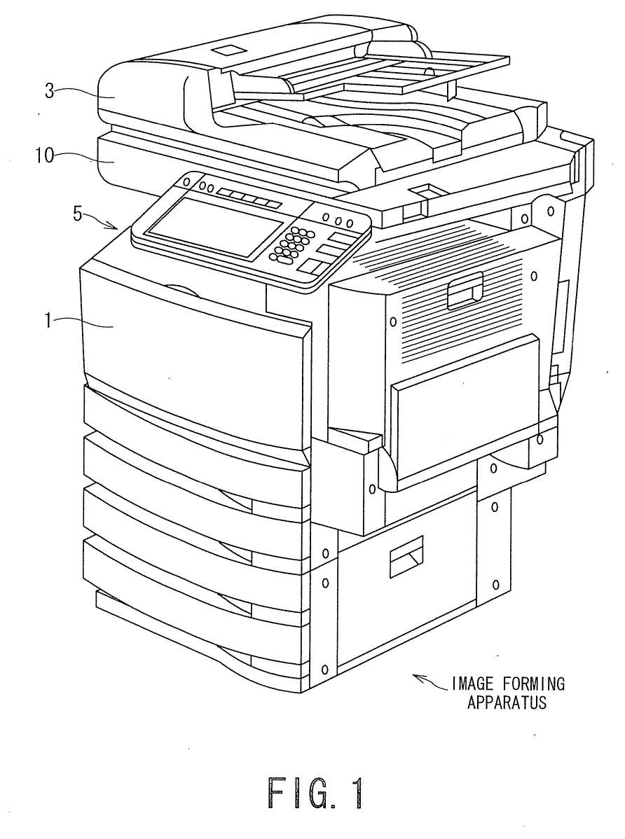

FIG. 1 shows an external construction of an image forming apparatus according to the present invention.

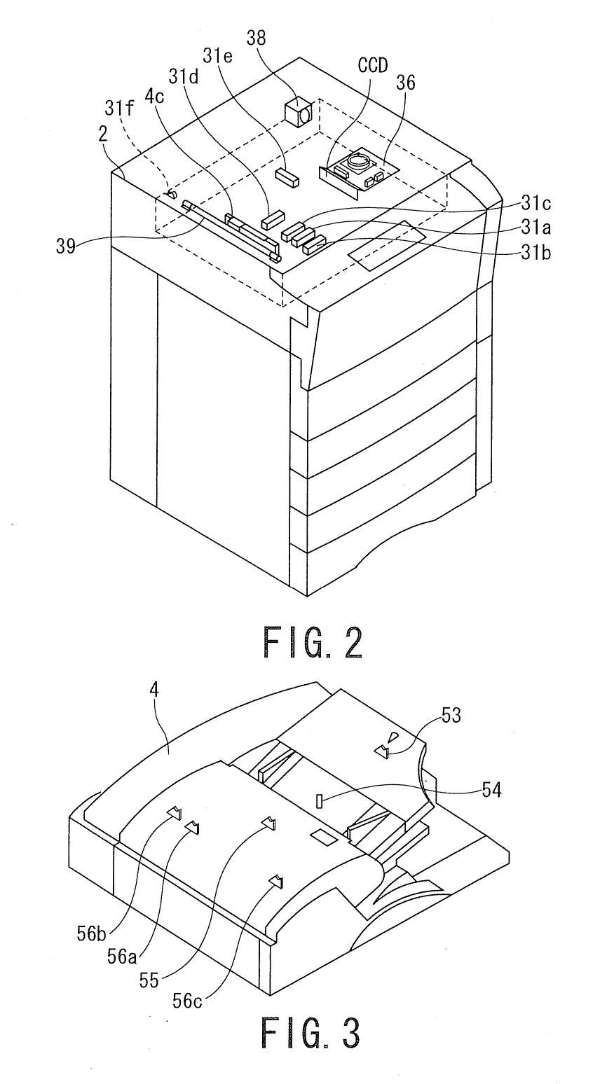

As shown in FIG. 1, the image forming apparatus is constructed by a scanning device 3, an operating unit 5, and a platen glass 10. In addition the image forming apparatus is provided with, not shown, a first detection unit (a first detection unit 2 in FIG. 2) and not shown, a second detection unit (a second detection unit 4 in FIG. 3). The first detection unit detects whether a first original is set on a platen glass 10 of the image forming apparatus or not. The second detection unit detects whether a second original is set on a scanning device 3 or not. Thus, the presence or absence of the original (the first original and the second original) is accordingly checked in the image forming apparatus.

An operation unit 5 has a display panel (not shown) for inputting various instructions of the user, and input devices such as various operation switches and various bottoms, and the like, which are used for the user to input various operations and setting of the image forming apparatus. Thus, when the user operates the operation unit 5, various operations and setting of the image forming apparatus can be performed in the image forming apparatus.

FIG. 2 shows a detail construction of the first detection unit 2 which is provided to the image forming apparatus in FIG. 1.

For example, as shown in FIG. 2, the first detection unit 2 is provided with an automatic original detection sensor 31 which is used for detecting whether the first original is set on a platen glass 10 of the image forming apparatus or not. To be more specific, the automatic original detection sensor 31 is composed of plural sensors (for example, a light sensor and an infrared sensor, etc.). For example, the automatic original detection sensor 31 has an automatic original detection sensor 31a, an automatic original detection sensor 31b, an automatic original detection sensor 31c, an automatic original detection sensor 31d, an automatic original detection sensor 31e, and a home position sensor 31f. In addition, the detection unit 2 is furthermore provided with a SLG board 36, a scan motor 38, an exposure lamp 39, and a lamp inverter board 40.

It should be noted that when the first original is set on the platen glass 10, the first detection unit 2 can detect not only the presence or absence of the first original with use of the automatic original detection sensor 31 but also a size of the first original.

When the first original set on the platen glass 10 is scanned by the image forming apparatus, the image forming apparatus exposures the first original set on the platen glass 10 while the image forming apparatus drives the exposure lamp 39 controlled by the lamp inverter board 40 with use of the scan motor 38. In this case, after the exposure of the first original, the light from the exposure lamp 39 is inputted in a CCD (not shown), and also the light from the exposure lamp 39 is photoelectrically converted to an analog signal by the CCD. The data after the photoelectric conversion is scanned into the image forming apparatus as an image data.

FIG. 3 shows a detail construction of the second detection unit 4 which is provided in the image forming apparatus in FIG. 1.

For example, as shown in FIG. 3, the second detection unit 4 is provided with plural sensors which are used for detecting whether a second original is set on a scanning device 3 or not. To be more specific, these sensors are composed of, for example, a light sensor and an infrared sensor, etc. For example, these sensors include an original tray sensor 53, an original tray width sensor 54, an original registration sensor 55, and an original width detection sensor 56 (original width detection sensors 56a to 56c).

It should be noted that when the second original is set on the scanning device 3, the first detection unit 2 can detect not only the presence or absence of the second original but also a size of the second original with use of the original width detection sensor 56.

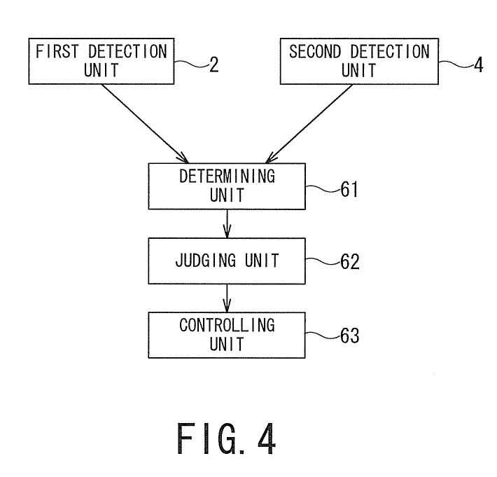

FIG. 4 is a block diagram showing a functional construction executable by an image forming apparatus in FIG. 1 to FIG. 3. It should be noted that the same numerals are given to the parts corresponding to those in the construction of the image forming apparatus in FIG. 1 to 3.

The first detection unit 2 detects whether the first original is set on the platen glass 10 of the image forming apparatus or not. At this time, the first detection unit 2 generates a first detection signal, and accordingly, supplies the thus generated first signal to a determining unit 61.

The second detection unit 4 detects whether or not the second original is set on the scanning device 3 of the image forming apparatus in order to scan originals in series. At this time, the second detection unit 4 generates a second detection signal, and accordingly, supplies the thus generated second signal to a determining unit 61.

In response to the first signal supplied from the first detection unit 2 and the second signal supplied from the second detection unit 4, the determining unit 61 determines that at least one of the first original and the second original is scanned.

A judging unit 62 judges whether or not the first original is a setting seat which is used for changing a setting related to the image forming apparatus when the first original is scanned in accordance with the determination by the determining unit 61.

A controlling unit 63 changes the setting related to the image forming apparatus (that is, system setting of the image forming apparatus) based on a data related to the setting seat as the first original if the judging unit 62 judges that the first original is the setting seat.

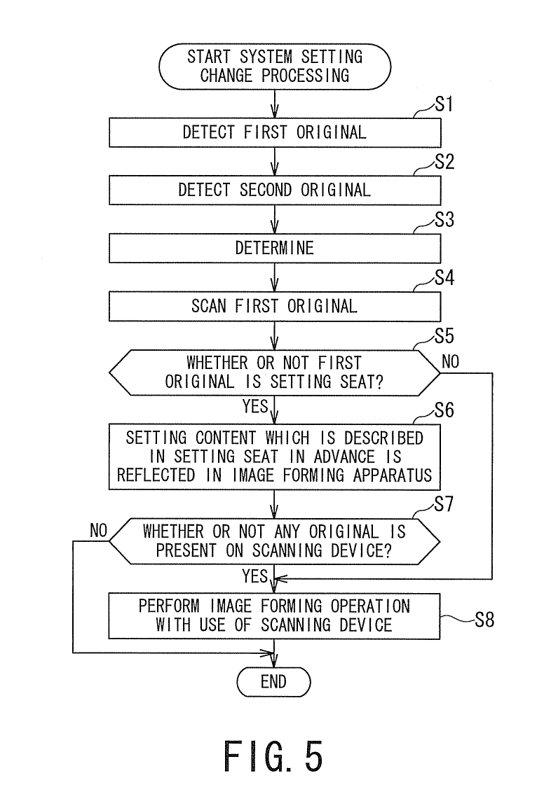

Next, with reference to flowchart of FIG. 5, a system setting change processing of the image forming apparatus in FIG. 4 will be described. The system setting change processing starts when the user set the first original on the platen glass 10 or set the second original on the scanning device 3.

In Step S1, the first detection unit 2 detects whether the first original is set on the platen glass 10 of the image forming apparatus or not. At this time, the first detection unit 2 generates the first detection signal, and accordingly, supplies the thus generated first signal to the determining unit 61.

In Step S2, the second detection unit 4 detects whether the second original is set on the scanning device 3 of the image forming apparatus or not. At this time, the second detection unit 4 generates the second detection signal, and accordingly, supplies the thus generated second signal to the determining unit 61.

In Step S3, when the user operates a start button of the operating unit 5 (not shown), in response to the first signal supplied from the first detection unit 2 and the second signal supplied from the second detection unit 4, the determining unit 61 determines that at least one of the first original and the second original is scanned.

According to the embodiment of the present invention, it is determined that the first original set on the platen glass 10 is scanned when the user set the first original on the platen glass 10 and also set the second original on the scanning device 3.

In Step S4, the image forming apparatus performs a process of scanning the first original set on the platen glass 10 in accordance with the determination by the determining unit 61. To be more specific, the image forming apparatus exposures the first original set on the platen glass 10 while the image forming apparatus drives the exposure lamp 39 controlled by the lamp inverter board 40 with use of the scan motor 38. In this case, after the exposure of the first original, the light from the exposure lamp 39 is inputted in a CCD (not shown), and also the light from the exposure lamp 39 is photoelectrically converted to an analog signal by the CCD. The data after the photoelectric conversion is scanned into the image forming apparatus as an image data (an image data related to the first original).

In Step S5, the judging unit 62 judges whether or not the first original is the setting seat which is used for changing the setting related to the image forming apparatus when the first original is scanned in accordance with the determination by the determining unit 61.

To be more specific, for example, by judging whether or not the image in response to the first original scanned is formed by a predetermined bar-code and a predetermined format, it is judged whether or not the first original scanned by the image forming apparatus is the setting seat which is used for changing a setting related to the image forming apparatus. It is needless to mention that it may be judged whether or not the first original scanned by the image forming apparatus is the setting seat which is used for changing a setting related to the image forming apparatus, with use of another method.

In Step S5, if it is judged by the judging unit 62 that the first original scanned by the image forming apparatus is the setting seat which is used for changing a setting related to the image forming apparatus, in accordance with this judgment by the judging unit 62, the controlling unit 63 changes the setting related to the image forming apparatus (that is, system setting of the image forming apparatus) based on the data related to the setting seat as the first original (the setting data) in Step S6. Thus, a setting content which is described in the setting seat in advance is reflected in the image forming apparatus. Thus, setting data includes, for example, informations related to various setting in printing such as a color mode, a monochrome mode, a full color mode, and the like.

In Step S7, the image forming apparatus judges whether or not any original is present on the scanning device 3 on the basis of the second signal supplied from the second detection unit 4. In Step S7, if it is judged that some original is present on the scanning device 3, the image forming apparatus performs an image forming operation with use of the scanning device 3 in Step S8. On the other hand, in Step S7, if it is judged that some original is absent on the scanning device 3, the image forming operation in Step S8 is skipped. Thereafter, the image forming apparatus ends the system setting change processing.

In Step S5, if it is judged that the first original scanned by the image forming apparatus is not the setting seat which is used for changing a setting related to the image forming apparatus, the processes in Steps S6 and S7 is skipped. Thereafter, the process advances to Step S8, and the image forming operation with use of the scanning device 3 is performed in Step S8.

According to the embodiment of the present invention, it is detected whether the first original is set on the platen glass 10 or not, and it is also detected whether the second original is set on the scanning device 3 in order to scan originals in series or not, it is determined that at least one of the first original and the second original is scanned in response to the first detection signal generated by the first detecting unit 2, and the second detection signal generated by the second detecting unit 4. It is judged whether the first original is the setting seat or not when the first original is scanned in accordance with the determination by the determining unit 61.

And the setting of the image forming apparatus is changed the setting of the image forming apparatus (system setting related to the image forming apparatus) based on the data related to the setting seat for the first original if it is judged that the first original is the setting seat. Thus, it is possible to prevent deterioration of the setting seat, and avoid the trouble of having to treat the setting seat if the user manages the setting seat by putting the setting seat into a clear case. As a result, it is possible to allow the improvement of usability and availableness of the image forming apparatus.

It should be noted that the setting seat which is used for changing the setting related to the image forming apparatus may be damaged and polluted with repeated use and management state. In addition, the setting seat may have defects (omission of recording) in itself. In this case, although it is judged that the original scanned by the image forming apparatus is the setting seat, it is difficult that the setting content which is described in the setting seat in advance is reflected in the image forming apparatus.

In view of the above description, if it is judged that the original scanned by the image forming apparatus is the setting seat, it is judged whether or not the setting seat is capable of being reflected in the image forming apparatus. If it is judged that the setting seat is capable of being reflected in the image forming apparatus, the setting content which is described in the setting seat in advance may be reflected in the image forming apparatus. Hereinafter, the system setting change processing with use of this method will be described.

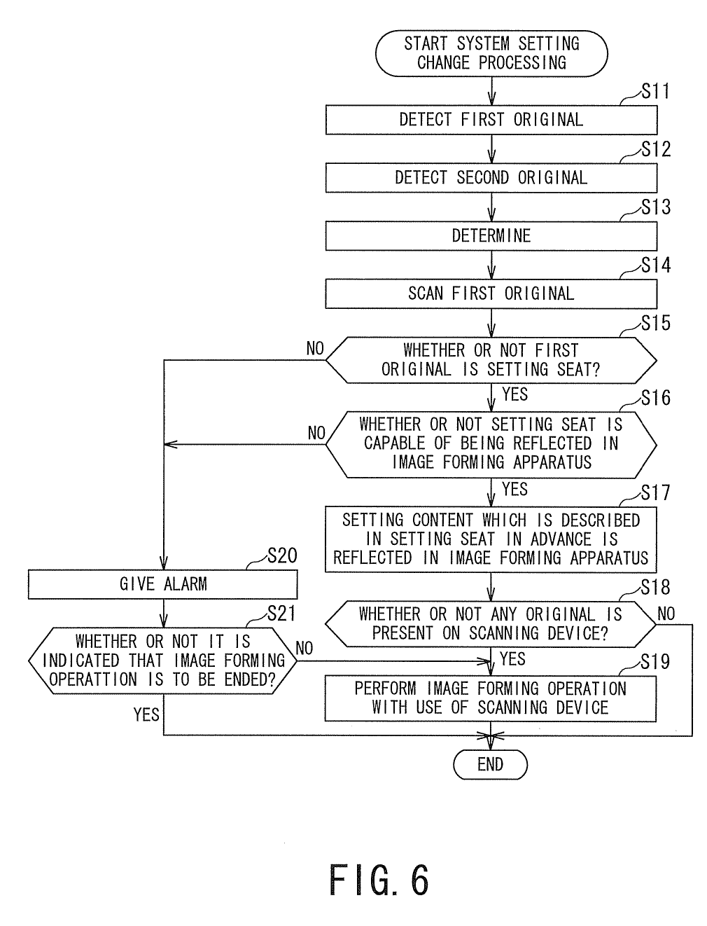

With reference to flowchart of FIG. 6, another system setting change processing of the image forming apparatus in FIG. 4 will be described. It should be noted that the processes in Steps S11 to S15, and Steps S17 to S19 of FIG. 6 are similar to those in Steps S1 to S8 of FIG. 5, and a description thereof will be omitted to avoid the repetition.

In Step S15, if it is judged that the original scanned by the image forming apparatus is the setting seat which is used for changing the setting related to the image forming apparatus, the judging unit 62 judges whether or not the setting seat is capable of being reflected in the image forming apparatus (that is, whether the setting seat has any defects or not) in FIG. 16.

In Step 16, if it is judged that the setting seat is capable of being reflected in the image forming apparatus (that is, that the setting seat has no defect), the process advances to Step S17, the setting related to the image forming apparatus (system setting of the image forming apparatus) is changed with use of the setting seat in the processes in Step S15 and subsequent steps, and also the image forming operation with use of the scanning device 3 is performed. Thereafter, the image forming apparatus ends the system setting change processing.

On the other hand, in Step S15, if it is judged that the original scanned by the image forming apparatus is not the setting seat which is used for changing the setting related to the image forming apparatus, or in the Step S16, if it is judged that the setting seat is not capable of being reflected in the image forming apparatus (that is, that the setting seat has some defects), the image forming apparatus gives an alarm to the user. For example, if it is judged that the setting seat is not capable of being reflected in the image forming apparatus (that is, that the setting seat has some defects), the image forming apparatus gives an alarm to the user that the setting content described in the setting seat can not be reflected on the setting of the image forming apparatus because of some defects in the setting seat (for example, a display by a message dialogue, and an audible alarm, etc.). It is needless to mention that this alarm is given in a personal computer (not shown) which is connected to the image forming apparatus via a network.

In Step S21, the judging unit 62 judges whether or not it is indicated that the image forming operation is to be ended (that is, a scanning of the second original by the scanning device 3 is to be ended), when the user operates the operation unit 5. In Step S21, if it is judged that it is not indicated that the image forming operation is to be ended (that is, the scanning of the second original by the scanning device 3 is to be ended), the changing of the system setting related to the image forming apparatus with use of the setting seat is not performed, and the process advances to Step S19. The image forming operation by the scanning device 3 with use of the current system setting of the image forming apparatus is performed.

On the other hand, in Step S21, if it is judged that it is indicated that the image forming operation is to be ended (that is, the scanning of the second original by the scanning device 3 is to be ended), the image forming apparatus ends the system setting change processing.

Herewith, the user recognizes that the setting seat set on the platen glass 10 has some sort of defects and accordingly, the setting seat is not capable of being reflected in the image forming apparatus. Thus, it is possible to prevent deterioration of the setting seat, and avoid the trouble of having to treat the setting seat if the user manages the setting seat by putting the setting seat into a clear case. As a result, it is possible to allow the improvement of usability moreover and availableness of the image forming apparatus moreover.

It should be noted that if in spite of recognizing that the first original is the setting seat, the image forming apparatus can not scan all or part of the setting seat because of the damage and pollution in the setting seat, the image forming apparatus gives the alarm to the user as mentioned above, and also the image forming apparatus may cancel a subsequent scanning movement of the setting seat, or, may reflect only a scanned partial setting content described in the setting seat in the setting of the image forming apparatus.

Incidentally, in the system setting change processing described with reference to flowcharts of FIG. 5 and FIG. 6, the setting of the image forming apparatus is changed with use of only the setting seat, but the present invention is not limited to the above-mentioned case. When the user indicate to the image forming apparatus a changing of the setting related to the image forming apparatus with use of the operating unit 5, the image forming apparatus performs preferentially the changing of the setting related to the image forming apparatus. Hereinafter, the system setting change processing with use of this method will be described.

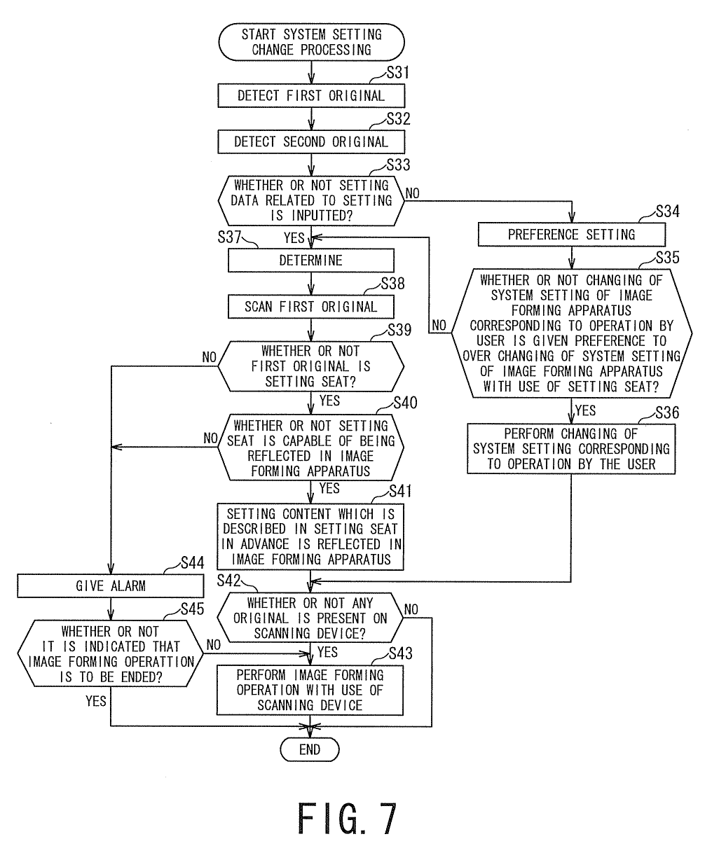

With reference to flowchart of FIG. 7, another system setting change processing of the image forming apparatus in FIG. 4 will be described. It should be noted that the processes in Steps S31 to S32, and Steps S37 to S45 of FIG. 7 are similar to those in Steps S11 to S21 of FIG. 6, and a description thereof will be omitted to avoid the repetition.

In Step S33, the image forming apparatus judges whether or not the setting data related to setting of the image forming apparatus is inputted when the user operates the operation unit 5. In the judging process in Step S33, it is judged whether or not a setting data related to setting (system setting) of the image forming apparatus which is different from a default setting of the image forming apparatus is inputted when the user operates the operation unit 5.

In Step S33, if it is judged that a setting data related to setting of the image forming apparatus is not inputted, the process advances to Step S37, and the processes in Step S37 and subsequent steps are performed.

On the other hand, In Step S33, if it is judged that a setting data related to setting of the image forming apparatus is inputted, the image forming apparatus sets in accordance with an operation by the user whether a changing of the system setting of the image forming apparatus corresponding to the operation by the user is given preference to over a changing of the system setting of the image forming apparatus with use of the setting seat, or the changing of the system setting of the image forming apparatus with use of the setting seat is given preference to over the changing of the system setting of the image forming apparatus corresponding to the operation by the user, in Step S34. At this time, for example, the image forming apparatus may display a dialogue related to a setting of preference on a display panel (not shown) of the operating unit 5 in each time and accordingly, prompt the user to check the setting of preference. In addition, before the system setting change processing, when the user operates the operating unit 5, the image forming apparatus may set that the changing of the system setting of the image forming apparatus with use of the setting seat, or the changing of the system setting of the image forming apparatus corresponding to the operation by the user is given preference to.

In Step S35, the image forming apparatus judges whether the changing of the system setting of the image forming apparatus corresponding to the operation by the user is given preference to over a changing of the system setting of the image forming apparatus with use of the setting seat, or the changing of the system setting of the image forming apparatus with use of the setting seat is given preference to over the changing of the system setting of the image forming apparatus corresponding to the operation by the user. In Step S35, if it is judged that the changing of the system setting of the image forming apparatus corresponding to the operation by the user is not given preference to over the changing of the system setting of the image forming apparatus with use of the setting seat (that is, the changing of the system setting of the image forming apparatus with use of the setting seat is given preference to over the changing of the system setting of the image forming apparatus corresponding to the operation by the user), the process advances to Step S37, and the processes in Step S37 and subsequent steps are performed. That is, the first original set on the platen glass 10 is scanned, and the setting content which is described in the setting seat in advance is reflected in the image forming apparatus if it is judged that the first original is the setting seat.

In Step S35, if it is judged that the changing of the system setting of the image forming apparatus corresponding to the operation by the user is given preference to over the changing of the system setting of the image forming apparatus with use of the setting seat, the controlling unit 63 of the image forming apparatus performs the changing of the system setting of the image forming apparatus corresponding to the operation by the user in Step S36. Thereafter, the process advances to Step S42, and the processes in Step S42 and subsequent steps are performed. Thus, it is possible to change the system setting of the image forming apparatus without using the setting seat when the user operates the operating unit 5. As a result, it is possible to allow the improvement of the availableness of the image forming apparatus moreover.

It should be noted that the changing of the system setting of the image forming apparatus corresponding to the operation by the user may be combined with the changing of the system setting of the image forming apparatus with use of the setting seat. Hereinafter, the system setting change processing with use of this method will be described.

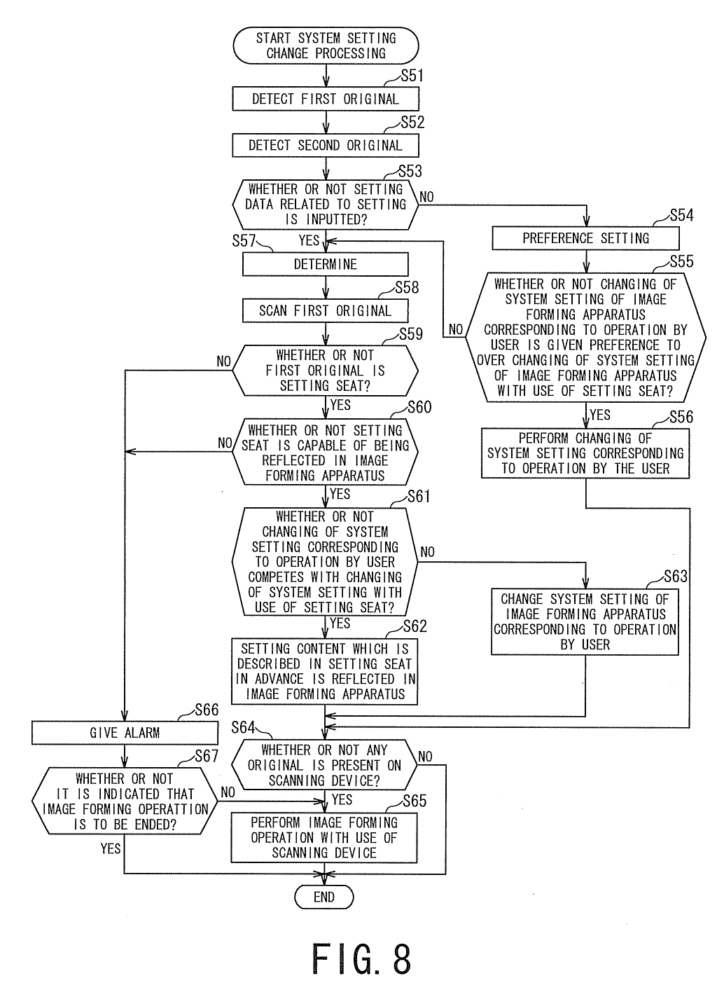

With reference to flowchart of FIG. 8, another system setting change processing of the image forming apparatus in FIG. 4 will be described. It should be noted that the processes in Steps S51 to S60, and Steps S64 to S67 of FIG. 8 are similar to those in Steps S31 to S40, and Steps S42 to S45 of FIG. 7, and a description thereof will be omitted to avoid the repetition.

In Step S61, the image forming apparatus judged whether or not the changing of the system setting of the image forming apparatus corresponding to the operation by the user competes with the changing of the system setting of the image forming apparatus with use of the setting seat.

In Step S61, if it is judged that the changing of the system setting of the image forming apparatus corresponding to the operation by the user competes with the changing of the system setting of the image forming apparatus with use of the setting seat, the controlling unit 63 of the image forming apparatus preferentially performs the changing of the system setting of the image forming apparatus corresponding to the operation by the user in Step S62. Thus, if the changing of the system setting of the image forming apparatus corresponding to the operation by the user competes with the changing of the system setting of the image forming apparatus with use of the setting seat, the image forming apparatus can perform not the changing of the system setting of the image forming apparatus with use of the setting seat but the changing of the system setting of the image forming apparatus corresponding to the operation by the user. It is needless to mention that the image forming apparatus may preferentially perform the changing of the system setting of the image forming apparatus with use of the setting seat if it is judged that the changing of the system setting of the image forming apparatus corresponding to the operation by the user competes with the changing of the system setting of the image forming apparatus with use of the setting seat.

On the other hand, in Step S61, if it is judged that the changing of the system setting of the image forming apparatus corresponding to the operation by the user does not compete with the changing of the system setting of the image forming apparatus with use of the setting seat, the controlling unit 63 of the image forming apparatus changes the setting related to the image forming apparatus (system setting) on the basis of the data related to the setting seat as the first original, and also changes the setting out of these setting related to the image forming apparatus on the basis of the changing of the system setting of the image forming apparatus corresponding to the operation by the user in Step S63. Thus, the changing of the system setting of the image forming apparatus corresponding to the operation by the user in combination with the changing of the system setting of the image forming apparatus with use of the setting seat is reflected in the image forming apparatus. As a result, it is possible to allow the improvement of the availableness of the image forming apparatus moreover.

Incidentally, when the image forming apparatus scans the setting seat with originals with use of the scanning device 3, and accordingly, changes the system setting of the image forming apparatus, it is necessary that the image forming apparatus scans the setting seat (another setting seat) once again with use of the scanning device 3 after some originals were scanned by the scanning device 3, and changes the system setting of the image forming apparatus with use of the setting seat as well, in order that the system setting of the image forming apparatus is changed from the already changed system setting of the image forming apparatus to a new system setting of the image forming apparatus. For the reason, when the system setting of the image forming apparatus is changed in the middle of a printing of originals, the image forming apparatus must temporarily stop a printing job, and repeatedly perform the changing of the system setting of the image forming apparatus with use of the setting seat.

In view of the above description, in advance, the user accordingly puts the setting seats into originals at respective levels of changing the system setting of the image forming apparatus. And the system setting of the image forming apparatus may be changed with use of respective setting seats when respective setting seats put into originals are scanned. Hereinafter, the system setting change processing with use of this method will be described.

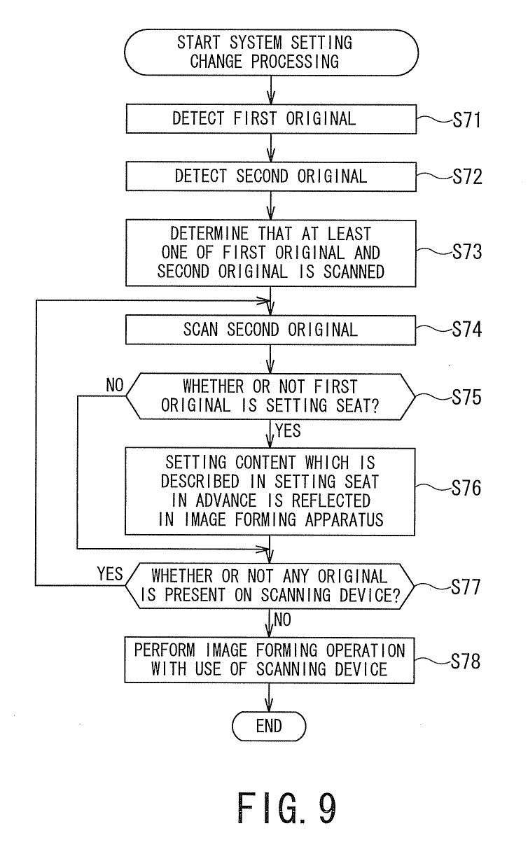

With reference to flowchart of FIG. 9, another system setting change processing of the image forming apparatus in FIG. 4 will be described. It should be noted that the system setting change processing starts when the user set the second original on the scanning device 3.

In Step S71, the first detection unit 2 detects whether the first original is set on the platen glass 10 of the image forming apparatus or not. At this time, the first detection unit 2 generates the first detection signal, and accordingly, supplies the thus generated first signal to the determining unit 61.

In Step S72, the second detection unit 4 detects whether the second original is set on the scanning device 3 of the image forming apparatus or not. At this time, the second detection unit 4 generates the second detection signal, and accordingly, supplies the thus generated second signal to the determining unit 61.

In Step S73, when a user operates a start button of the operating unit 5 (not shown), on the basis of the first signal supplied from the first detection unit 2 and the second signal supplied from the second detection unit 4, the determining unit 61 determines that at least one of the first original and the second original is scanned.

In this case, it is determined by the determining unit 61 that the second original set on the scanning device 3 is scanned.

In Step S74, the image forming apparatus only once performs the process of scanning the second original set on the scanning device 5 in accordance with the determination by the determining unit 61.

In Step S75, the judging unit 62 judges whether or not the second original is the setting seat which is used for changing the setting related to the image forming apparatus when the first original is scanned in accordance with the determination by the determining unit 61. A specific judging method in this case is similar to the judging method in Steps S5 of FIG. 5, and a description thereof will be omitted to avoid the repetition.

In Step S75, if it is judged that the second original scanned by the image forming apparatus is the setting seat which is used for changing the setting related to the image forming apparatus, in accordance with this judgment by the judging unit 62, the controlling unit 63 changes the setting related to the image forming apparatus (that is, system setting of the image forming apparatus) based on the data related to the setting seat as the second original in Step S76. Thus, the setting content which is described in the setting seat in advance is reflected in the image forming apparatus. As a result, it is possible that the image forming apparatus subsequently performs the image forming operation with use of the setting content which is described in the setting seat in advance.

On the other hand, In Step S75, if it is judged that the second original scanned by the image forming apparatus is not the setting seat which is used for changing a setting related to the image forming apparatus, the process in Step S76 is skipped, the process advances to Step S77.

In Step S77, the image forming apparatus judges whether or not any originals are present on the scanning device 3 on the basis of the second signal supplied from the second detection unit 4. In Step S77, if it is judged that some originals are present on the scanning device 3, the process advances to Step S74, the processes in Step S74 and subsequent steps are performed. Thus, originals are scanned in order of precedence till originals are absent on the scanning device 3. On the other hand, In Step S77, if it is judged that any originals are not present on the scanning device 3, the image forming apparatus performs the image forming operation of originals scanned by the scanning device 3 in Step S78. That is, when the system setting of the image forming apparatus is sometimes changed with use of the setting seat in the middle of a printing of originals, the image forming operation of originals is performed with use of respective system settings of the image forming apparatus.

Thus, when the user desires the system setting of the image forming apparatus is changed in the middle of a printing of originals, the user makes the image forming apparatus perform the image forming operation of originals with use of respective system settings of the image forming apparatus by scanning originals with use of the scanning device 3 in series, without temporarily stopping the image forming operation of originals. As a result, it is possible to allow the improvement of the availableness of the image forming apparatus moreover.

It should be noted that if it is judged that a competing system setting is present, a priority for giving preference to any of the setting may be set in advance, or the image forming apparatus may prompt the user to check the setting of preference with use of the panel (not shown) of the operating unit 5.

Then, the series of processes described in the embodiment of the present invention can be executed by a software as well as a hardware.

Furthermore, according to the embodiment of the present invention, for the steps in the flowcharts, the example in which the processes are executed in the stated order in a time oriented manner has been described, but an example in which the processes are executed in parallel or individually executed while not necessarily executed in the time oriented manner may also be included in the steps.

What is claimed is:

1. An image forming apparatus, comprising:
a first detecting unit configured to detect whether a first original is set on a platen glass or not;
a second detecting unit configured to detect whether a second original is set on a scanning device in order to scan originals in series or not;
a determining unit configured to determine that at least one of the first original and the second original is scanned in response to a detection signal generated by the first detecting unit when the first detecting unit detects the setting of the first original, and a detection signal generated by the second detecting unit when the second detecting unit detects the setting of the second original;
a first judging unit configured to judge whether the first original is a setting seat or not when the first original is scanned in accordance with determination by the determining unit; and
a changing unit configured to change a setting of the image forming apparatus based on a data related to the setting seat as the first original if the first judging unit judges that the first original is the setting seat.

2. The image forming apparatus according to claim 1, wherein the determining unit determines that the first original is scanned if the setting of the first original on the platen glass is detected by the first detecting unit, determines that the second original is scanned if the setting of the second original on the scanning device is detected by the second detecting unit, determines that the first original and the second original are scanned if the setting of the first original on the platen glass is detected by the first detecting unit and the setting of the second original on the scanning device is detected by the second detecting unit.

3. The image forming apparatus according to claim 1, wherein the scanning device scans the second original in accordance with the determination by the determining unit even if the first original is set on the platen glass.

4. The image forming apparatus according to claim 1, further comprising:
a second judging unit configured to judge whether the setting seat has a defect or not if the first judging unit judges that the first original is the setting seat; and
an alarm giving unit configured to give an alarm that if the second judging unit judges that the setting seat has the defect, a setting content described in the setting seat can not be reflected in the setting of the image forming apparatus because of the defect in the setting seat.

5. The image forming apparatus according to claim 4, wherein the changing unit changes the setting of the image forming apparatus based on the data related to the setting seat as the first original if the second judging unit judges that the setting seat has no defect.

6. The image forming apparatus according to claim 4, wherein the changing unit partly changes the setting of the image forming apparatus based on the data of the setting seat as the first original if the second judging unit judges that the setting seat has a partial defect.

7. The image forming apparatus according to claim 1, further comprising:
an inputting unit configured to input a setting data related to the image forming apparatus,
wherein the changing unit changes the setting of the image forming apparatus based on the setting data inputted by the inputting unit.

8. The image forming apparatus according to claim 7, further comprising:
a second judging unit configured to judge whether a changing of the setting of the image forming apparatus based on the setting data inputted by the inputting unit is given preference to over a changing of the setting of the image forming apparatus based on the setting seat, or ,the changing of the setting of the image forming apparatus based on the setting seat is given preference to over the changing of the setting of the image forming apparatus based on the setting data inputted by the inputting unit,
wherein the changing unit changes the setting of the image forming apparatus based on the setting data inputted by the inputting unit if the second judging unit judges that the changing of the setting of the image forming apparatus based on the setting data inputted by the inputting unit is given preference to over the changing of the setting of the image forming apparatus based on the setting seat.

9. The image forming apparatus according to claim 8, wherein the changing unit changes the setting of the image forming apparatus based on the data related to the setting seat if the second judging unit judges that the changing of the setting of the image forming apparatus based on the setting seat is given preference to over the changing of the setting of the image forming apparatus based on the setting data inputted by the inputting unit.

10. The image forming apparatus according to claim 7, further comprising:
a second judging unit configured to judge whether or not a changing of the setting of the image forming apparatus based on the setting seat competes with a changing of the setting of the image forming apparatus based on the setting data inputted by the inputting unit;
wherein the changing unit changes the setting of the image forming apparatus based on the setting data inputted by the inputting unit if the second judging unit judges that the changing of the setting of the image forming apparatus based on the setting seat competes with the changing of the setting of the image forming apparatus based on the setting data inputted by the inputting unit.

11. The image forming apparatus according to claim 10, wherein the changing unit changes the setting of the image forming apparatus based on the setting data inputted by the inputting unit and the data related to the setting seat if the second judging unit judges that the changing of the setting of the image forming apparatus based on the setting seat does not compete with the changing of the setting of the image forming apparatus based on the setting data inputted by the inputting unit.

12. A method of controlling an image forming apparatus, comprising:
detecting whether a first original is set or not;
detecting whether a second original is set or not;
determining that at least one of the first original and the second original is scanned in response to a detection signal generated when the setting of the first original is detected, and a detection signal generated when the setting of the second original is detected;
judging whether the first original is a setting seat or not when the first original is scanned in accordance with determination; and
changing a setting of the image forming apparatus based on a data related to the setting seat as the first original if it is judged that the first original is the setting seat.

13. A controlling program for the image forming apparatus for causing a computer to execute a procedure, comprising:
detecting whether a first original is set or not;
detecting whether a second original is set or not;
determining that at least one of the first original and the second original is scanned in response to a detection signal generated when the setting of the first original is detected, and a detection signal generated when the setting of the second original is detected;
judging whether the first original is a setting seat or not when the first original is scanned in accordance with determination; and
changing a setting of the image forming apparatus based on a data related to the setting seat as the first original if it is judged that the first original is the setting seat.

14. An image forming apparatus, comprising:
a first detecting unit configured to detect whether a first original is set on a platen glass or not;
a second detecting unit configured to detect whether a second original is set on a scanning device in order to scan originals in series or not;
a determining unit configured to determine that at least one of the first original and the second original is scanned in response to a detection signal generated by the first detecting unit when the first detecting unit detects the setting of the first original, and a detection signal generated by the second detecting unit when the second detecting unit detects the setting of the second original;
a judging unit configured to judge whether the second original is a setting seat or not when the second original is scanned in accordance with determination by the determining unit;
a changing unit configured to change a setting of the image forming apparatus each time based on a data related to the setting seat as the second original if the judging unit judges that the first original is the setting seat; and
an executing unit configured to execute an image forming operation by using the setting of the image forming apparatus changed by the changing unit until the changing unit furthermore changes the setting of the image forming apparatus with use of another setting seat.

15. A method of controlling an image forming apparatus, comprising:
detecting whether a first original is set or not;
detecting whether a second original is set or not;
determining that at least one of the first original and the second original is scanned in response to a detection signal generated when the setting of the first original is detected, and a detection signal generated when the setting of the second original is detected;
judging whether the second original is a setting seat or not when the second original is scanned in accordance with determination;
changing a setting of the image forming apparatus each time based on a data related to the setting seat as the second original if it is judged that the first original is the setting seat; and
executing an image forming operation by using the setting of the image forming apparatus changed until the setting of the image forming apparatus is furthermore changed with use of another setting seat.

16. A controlling program for the image forming apparatus for causing a computer to execute a procedure, comprising:
detecting whether a first original is set or not;
detecting whether a second original is set or not;
determining that at least one of the first original and the second original is scanned in response to a detection signal generated when the setting of the first original is detected, and a detection signal generated when the setting of the second original is detected;
judging whether the second original is a setting seat or not when the second original is scanned in accordance with determination;
changing a setting of the image forming apparatus each time based on a data related to the setting seat as the second original if it is judged that the first original is the setting seat; and
executing an image forming operation by using the setting of the image forming apparatus changed until the setting of the image forming apparatus is furthermore changed with use of another setting seat.
